(19) United States
(12) Patent Application Publication
(10) Pub. No.: US 2024/0387905 A1
(43) Pub. Date: Nov. 21, 2024

(54) BATTERY CASE

(71) Applicants: Hyundai Motor Company, Seoul (KR); Kia Corporation, Seoul (KR)

(72) Inventors: Gyung Hoon Shin, Seoul (KR); Gun Woo Ko, Seongnam-si (KR)

(21) Appl. No.: 18/494,279

(22) Filed: Oct. 25, 2023

(30) Foreign Application Priority Data
May 17, 2023 (KR) 10-2023-0063857

(51) Int. Cl. H01M 10/6567; H01M 10/613; H01M 10/625; H01M 50/249; H01M 50/271

(52) U.S. Cl. CPC H01M 10/6567; H01M 10/613; H01M 10/625; H01M 50/249; H01M 50/271; B60L 50/64; H01M 2220/20

(57) ABSTRACT

An embodiment battery case includes a lower part defining a bottom surface of the battery case, wherein the lower part is configured to have a battery module mounted thereon, is extruded and molded in a width direction of a vehicle, and comprises a cooling channel extending in the width direction of the vehicle, the cooling channel being configured to allow a cooling medium to flow therethrough, and a first side part coupled to an edge of the lower part to define a side of the battery case, wherein the first side part is extruded and molded in a longitudinal direction of the vehicle, and wherein the first side part includes an inlet/outlet channel extending in the longitudinal direction of the vehicle, the inlet/outlet channel being configured to allow the cooling medium to flow therethrough and a connection channel connecting the inlet/outlet channel and the cooling channel.

### CROSS-REFERENCE TO RELATED APPLICATIONS

This application claims the benefit of Korean Patent Application No. 10-2023-0063857, filed on May 17, 2023, which application is hereby incorporated herein by reference.

### TECHNICAL FIELD

The present disclosure relates to a battery case.

### BACKGROUND

Conventional gasoline/diesel vehicles have various problems such as emissions of air pollutants, and as an alternative to solve these problems, electric vehicles, hybrid electric vehicles, and plug-in hybrid electric vehicles are gaining attention.

Unlike conventional gasoline vehicles or diesel vehicles, electric vehicles are driven by obtaining power through secondary batteries. In order to power the electric vehicles, batteries with high performance such as high energy density, high power density, and light weight are essential, and it is also crucial to place more batteries in electric vehicles.

Yet, conventionally, a cooling system of a battery case is composed of a plate-shaped cooling plate that exchanges heat with a battery module, and a separate rigid support is required inside the battery case. This is because a battery may cause a fire or the like when damaged by an impact, and thus a certain degree of rigidity is required.

For this reason, conventional battery cases are designed in such a way as to increase rigidity by arranging a number of cross members inside. However, as the large number of cross members occupy the limited internal space of the battery case, the loading space for battery modules is reduced, eventually reducing the mileage of a vehicle.

Accordingly, a technology for a vehicle battery case that can improve utilization of the internal space while maintaining the existing rigidity and connectivity is required.

### SUMMARY

The present disclosure relates to a battery case. Particular embodiments relate to a battery case in which a lower part in charge of a cooling system of the battery case of a vehicle also integrally serves as a rigid support in the longitudinal direction of the battery case. According to embodiments of the present disclosure, it is possible to efficiently use the internal space of the battery case by reducing the number of cross members that are disposed in large numbers in the case of a conventional battery case.

An embodiment of the present disclosure provides a battery case and, more particularly, a battery case in which a lower part in charge of a cooling system of the battery case is extruded to extend in the width direction of a vehicle and performs an integrated role even as a rigid support in the longitudinal direction of the battery case.

An embodiment of the present disclosure provides a battery case that efficiently uses the internal space by simplifying the structure of a cross member, required in large numbers in the case of a conventional battery case, and reducing the number of cross members by means of a lower part that integrally plays the role of cooling a battery module and strengthening the rigidity in the longitudinal direction.

According to an embodiment of the present disclosure, there is provided a battery case including a lower part configured to constitute a bottom surface of the battery case, on which a battery module is mounted, extruded and molded in a width direction of a vehicle, and in which a cooling channel through which a cooling medium flows extends in the width direction of the vehicle, and a first side part coupled to an edge of the lower part to constitute a side of the battery case, extruded and molded in a longitudinal direction of the vehicle, in which an inlet/outlet channel through which the cooling medium flows extends in the longitudinal direction of the vehicle, and in which a connection channel connecting the inlet/outlet channel and the cooling channel is provided.

A plurality of lower parts may be disposed in contact with each other on the same plane to form the bottom surface of the battery case.

In the lower part, a plurality of cooling channels extending in the width direction may be provided, and the plurality of cooling channels may be spaced apart from each other in the longitudinal direction of the vehicle.

The first side part may be coupled to each side of the lower part, and an inlet channel may be provided in the first side part on a first side of the lower part while an outlet channel may be provided in the first side part on a second side of the lower part, wherein a cooling medium introduced through the inlet channel may pass through the cooling channel of the lower part and be discharged to the outside of the battery case through the outlet channel.

The inlet/outlet channel of the first side part may have a diameter in a height direction larger than that of the connection channel in the height direction.

A first end of the inlet/outlet channel of the first side part may be connected to a cooling line of the vehicle and a second end thereof may be closed by a closing portion.

The battery case of embodiments of the present disclosure may further include a battery upper case and a second side part located on top of the first side part and configured to constitute the side of the battery case together with the first side part, wherein an upper end of the second side part may be coupled to both ends of a lower surface of the battery upper case.

A joint portion configured to have a plurality of curves may be provided on a lower surface of the second side part and an upper surface of the first side part, wherein the second side part and the first side part may be connected through the joint portion.

On each side of the inside of the battery case, a mounting member extending in the longitudinal direction of the vehicle and surrounding a side of the mounted battery module may be provided, wherein the mounting member may be located on an upper surface of the lower part and may face the first side part laterally.

The mounting member and the first side part may be arranged to be spaced apart from each other, so that a separation space may be formed between the mounting member and the first side part.

The connection channel of the first side part may be located in the separation space and may connect the inlet/outlet channel and the cooling channel.

The battery case of embodiments of the present disclosure may further include a second side part coupled to a top of the first side part, wherein the first side part and the second side part each may form an outer protrusion, and wherein a lowermost end of the outer protrusion of the first side part may be located on the same line as a lowermost end of the lower part while an uppermost end of the outer protrusion of the second side part may be located on the same line as or higher than an uppermost end of the mounting member.

According to the structure of a battery case of embodiments of the present disclosure, as a lower part plays the role of a cooling system as well as a rigid support in the longitudinal direction of the battery case, the structure of a cross member, which is disposed in large numbers in the case of a conventional battery case, is simplified, and the number of cross members required is reduced.

Therefore, it is possible to load more battery modules in the battery case, so that the energy density of the vehicle is increased and the mileage can be increased.

In addition, by forming a passage through which a cooling medium can move in a first side part coupled to the side part of the battery case, no additional parts for distributing the cooling medium to a cooling channel are required unlike in the conventional case, so that a welding process can be saved and costs of battery case materials can be reduced.

### BRIEF DESCRIPTION OF THE DRAWINGS

FIG. 1 is a perspective view of a battery case according to an embodiment of the present disclosure;

FIG. 2 is a view showing a state in which a battery upper case is removed from the battery case shown in FIG. 1;

FIG. 3 is a view showing a state in which the battery upper case and a battery module are removed from the battery case shown in FIG. 1;

FIG. 4 is a view showing a portion of a cross section of the battery case shown in FIG. 1 taken along line A-A; and

FIG. 5 is a view showing a portion of a cross section of the battery case shown in FIG. 1 taken along line B-B.

### DETAILED DESCRIPTION OF ILLUSTRATIVE EMBODIMENTS

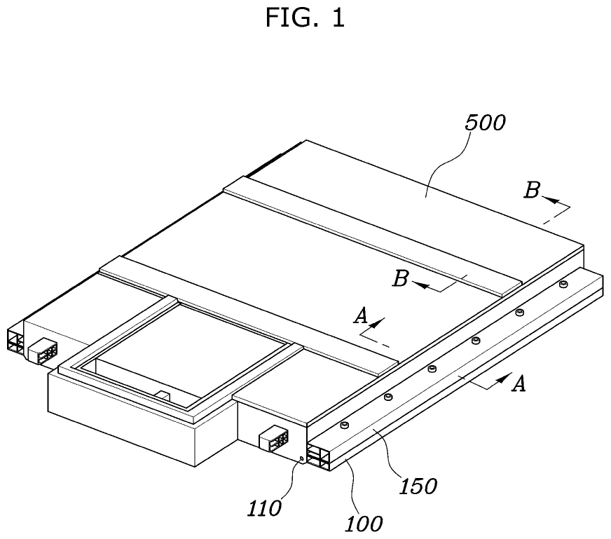

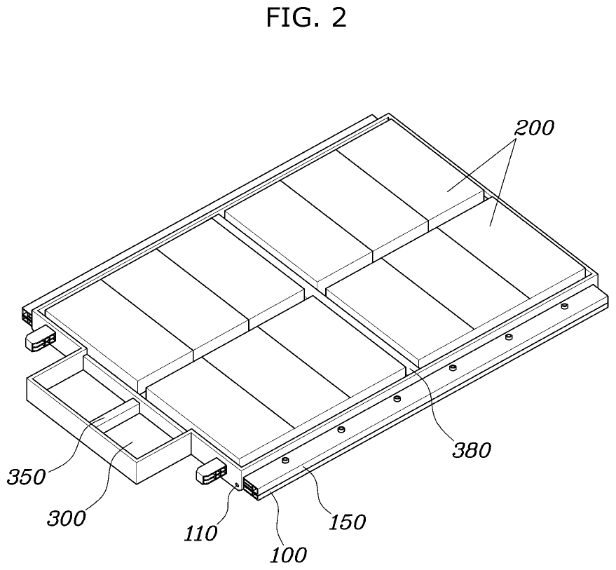

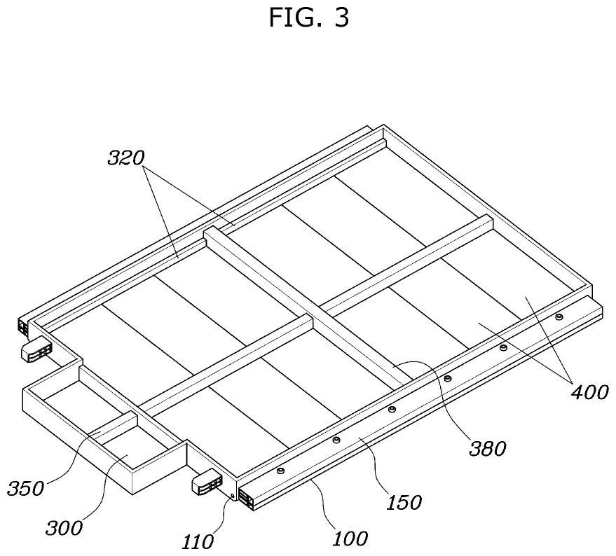

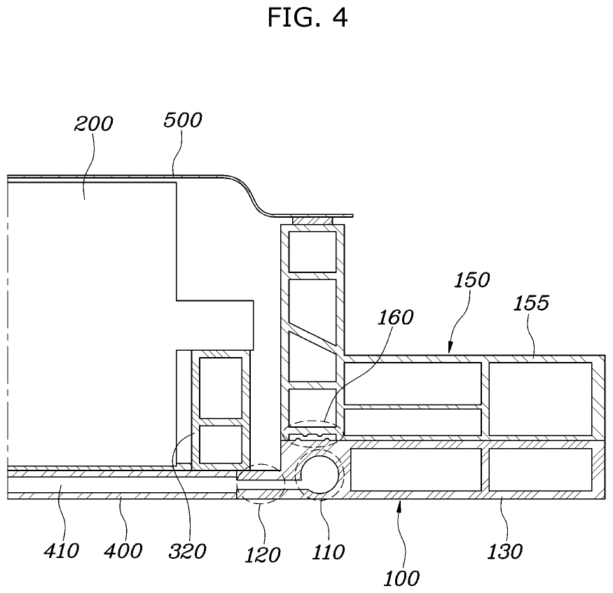

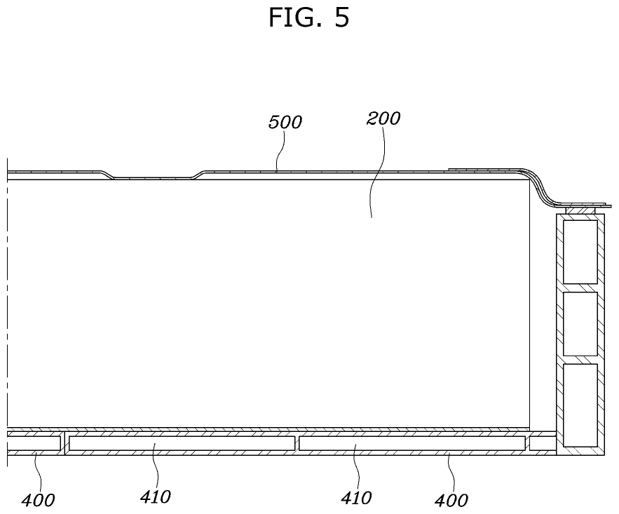

FIG. 1 is a perspective view of a battery case according to an embodiment of the present disclosure; FIG. 2 is a view showing a state in which a battery upper case is removed from the battery case shown in FIG. 1; FIG. 3 is a view showing a state in which the battery upper case and a battery module are removed from the battery case shown in FIG. 1; FIG. 4 is a view showing a portion of a cross section of the battery case shown in FIG. 1 taken along line A-A; and FIG. 5 is a view showing a portion of a cross section of the battery case shown in FIG. 1 taken along line B-B.

Hereafter, specific embodiments of the present disclosure will be described with reference to the accompanying drawings. However, this is only an example and the present disclosure is not limited thereto. In describing embodiments of the present disclosure, if it is decided that the detailed description of known technologies related to the present disclosure makes the subject matter of the embodiments described herein unclear, the detailed description is omitted. In addition, terms to be described later are terms defined in consideration of functions in the present disclosure, which may vary according to the intention or custom of a user or operator. Therefore, the definition should be made based on the contents throughout this specification. The technical spirit of the present disclosure is determined by the claims, and the following embodiments are only one means for efficiently explaining the technical idea of embodiments of the present disclosure to those skilled in the art to which the present disclosure pertains.

A battery case of embodiments of the present disclosure will be described with reference to FIGS. 1 to 3. The present embodiment includes a lower part 400 constituting the bottom surface of the battery case, on which a battery module 200 is mounted, extruded and molded in the width direction of a vehicle, and in which a cooling channel 410 through which a cooling medium flows extends in the width direction of the vehicle, and a first side part 100 coupled to the edge of the lower part 400 to constitute the side of the battery case, extruded and molded in the longitudinal direction of the vehicle, in which an inlet/outlet channel 110 through which the cooling medium flows extends in the longitudinal direction of the vehicle, and in which a connection channel 120 connecting the inlet/outlet channel 110 and the cooling channel 410 is provided.

In the conventional case, a cooling system of a battery case is molded and manufactured in a plate shape by a press method. Accordingly, rigidity in the longitudinal or transverse direction cannot be imparted to the battery case only by the cooling plate, and thus a plurality of cross members are additionally required in the battery case.

In this way, since a large number of cross members are provided in the limited inner space of the battery case, a problem arises that the loading space of battery modules is reduced. As a result, there is no choice but to load a small amount of battery modules, resulting in a decrease in the vehicle's mileage due to a decrease in the energy density of the vehicle.

In embodiments of the present disclosure, the lower part 400, which is in charge of a cooling system of the battery case, is extruded and molded in the width direction of the vehicle, and inside the lower part 400, the cooling channel 410 through which the cooling medium flows is provided extending in the width direction of the vehicle.

To be specific, first, a plurality of lower parts 400 are placed in contact with each other on the same plane to form the bottom surface of the battery case. The plurality of lower parts 400 molded by extrusion form the bottom surface of the battery case to supplement the longitudinal rigidity of the battery case. That is, specifically, in the battery case of embodiments of the present disclosure, the lower part 400 constituting the bottom surface is molded by an extrusion method.

It is not a simple extrusion, but by disposing a plurality of spaced-apart ribs extending in the longitudinal direction of the vehicle in the internal space of the lower part, the overall result is to have a plurality of members extending in the longitudinal direction of the vehicle. This secures the longitudinal impact stiffness. In particular, as the plurality of ribs in the longitudinal direction naturally form a cooling channel, eventually dual needs of rigidity and cooling may be satisfied by the lower part 400.

Unlike in the conventional case, as the lower part in charge of the cooling system integrally plays the role of a rigid support in the longitudinal direction of the battery case, the need to excessively place cross members inside the battery case is eliminated, so that the internal space of the battery case may be efficiently used. Therefore, more battery modules may be loaded in the same space, and the energy density of the vehicle may be improved.

Next, the inside of the lower part 400 will be described. A plurality of cooling channels 410 extending in the width direction are provided inside the lower part 400, and the plurality of cooling channels 410 are spaced apart from each other in the longitudinal direction of the vehicle. That is, the inside of the lower part 400 may have a lattice structure. The lattice structure has excellent rigidity and strength to density, so that the lower part 400 may effectively prepare for a side collision.

In addition, since the lower part 400 is molded by extrusion, the lower part 400 may be integrally formed using an extruded material without the need for additional processes such as combining separate parts, which has the advantage of excellent structural connectivity of parts and simple process. The internal lattice structure of the lower part 400 also has the advantage that it may be easily realized through extrusion molding.

Referring to FIGS. 1, 4, and 5, the side part of the battery case will be looked at. First, the first side part 100 will be described in detail. The first side part 100 is coupled to the edge of the lower part 400 to form the side of the battery case, is extruded and molded in the longitudinal direction of the vehicle, has the inlet/outlet channel 110 through which the cooling medium flows extending in the longitudinal direction of the vehicle therein, and has the connection channel 120 connecting the inlet/outlet channel 110 and the cooling channel 410 therein.

In the case of a conventional battery case, additional parts for distributing the cooling medium to the cooling channel 410 are required. However, in embodiments of the present disclosure, the inlet/outlet channel 110 and the connection channel 120 are provided in the first side part 100 constituting the side of the battery case, so that the first side part 100 integrally performs the role of protecting the side of the battery case and the role of distributing the cooling medium to the cooling channel 410.

Thus, the number of parts required for the battery case is reduced, and a welding process for combining additional parts is not required, resulting in process simplification and cost reduction.

The inlet/outlet channel 110 of the first side part 100 will be described. The first side part 100 is coupled to each side of the lower part 400, and an inlet channel is formed on one side thereof while an outlet channel is formed on the other side thereof. Accordingly, the cooling medium may be introduced through the inlet channel, distributed to the cooling channel, and discharged to the outside of the battery case through the outlet channel after heat exchange with the battery module.

To be specific, the inlet channel may be formed in the first side part 100 coupled to the right side of the lower part 400, while the outlet channel may be formed in the first side part 100 coupled to the left side of the lower part 400. Accordingly, the cooling medium may flow into the first side part 100 on the right side of the lower part 400 and be distributed to the cooling channel 410 of the lower part 400, and the distributed cooling medium may move to the left side of the lower part 400 and be discharged to the outside through the outlet channel. However, it is obvious that the positions of the inlet and outlet channels located on the left and right of the lower part 400 may be interchanged.

In addition, one end of the inlet/outlet channel 110 of the first side part 100 is connected to a cooling line of the vehicle and the other end is coupled with a closing portion to form a blocking structure. One end of the inlet/outlet channel 110 is connected to the cooling line of the vehicle so that the cooling medium of the vehicle may cool the battery module 200, while the other end of the inlet/outlet channel 110 forms the blocking structure so that the cooling medium flows in one direction and prevents the cooling medium from leaking.

In addition, by way of the closing portion, the first side part 100 may serve as a supply part supplying a cooling medium to the lower part 400. Various media may be used as the cooling medium, and cooling water may be used as a representative example. For parts such as the lower part 400 and the side part 100, by using aluminum, which is a lightweight metal, it is possible to secure moldability and increase heat transfer efficiency. When these various members are molded from the same aluminum material, there is an advantage in that welding is easy during assembly because they are made of the same material.

Next, the connection channel 120 of the first side part 100 will be described. The connection channel 120 connects the inlet/outlet channel 110 and the cooling channel 410. The connection channel 120 allows the cooling medium to be distributed to the cooling channel 410 when the cooling medium enters through the inlet channel 110, and then allows the cooling medium to be discharged through the outlet channel after heat exchange with the battery module 200. In addition, the connection channel 120 of the first side part 100 may be located in a separation space between a mounting member 320, which will be described later, and the first side part 100 to connect the cooling channel 410 and the inlet/outlet channel 110.

Meanwhile, the diameter of the inlet/outlet channel 110 in the height direction may be larger than the diameter of the connection channel 120 in the height direction. Since the diameter of the inlet/outlet channel 110 in the height direction is larger than the diameter of the connection channel 120 in the height direction, excessive inflow of the cooling medium into any one cooling channel 410 is prevented so that the cooling medium may be evenly distributed. By uniformly distributing the cooling medium in this way, the temperature deviation between the battery modules 200 may be reduced, thereby promoting stabilization of the battery system and the stability of the battery modules 200.

Next, the side part of the battery case will be described while additionally explaining a second side part 150. The second side part 150 is located on top of the first side part 100, and the upper surface of the second side part 150 is attached to both sides of the lower surface of a battery upper case 500. The second side part 150 protects the side of the battery case and serves to ensure battery airtightness.

Meanwhile, the second side part 150 may be formed separately from the first side part 100. When the first side part 100 and the second side part 150 are integrally formed, interference of the second side part 150 occurs during the process of mechanically connecting the connection channel 120 of the first side part 100 and the cooling channel 410, making it difficult to mechanically connect the connection channel 120 and the cooling channel 410, resulting in poor mass productivity.

In order to avoid this problem, when the first side part 100 is molded by an extrusion method so that the connection channel 120 is formed long, the rigidity of the connection channel 120 is insufficient, causing a problem of bending or deformation, which makes it impossible to manufacture.

Thus, in embodiments of the present disclosure, the first side part 100 and the second side part 150 are formed separately to ensure the mass productivity and manufacturability of the battery case.

As for the separately formed second side part 150 and the first side part 100, after the second side part 150 is positioned above the first side part 100, the second side part 150 and the first side part 100 are connected inward and outward by a process such as welding.

To be specific, a joint portion 160 having a plurality of curves is formed on the lower surface of the second side part 150 and the upper surface of the first side part 100, and the second side part 150 and the first side part 100 are connected through the joint portion 160. Since the plurality of curves are formed in the joint portion 160, the contact area is widened and the connection between the first side part 100 and the second side part 150 is strengthened. In addition, by preventing lateral sliding due to the curves, it is possible to secure mechanical fastening force upon welding.

The first side part 100 and the second side part 150 each form an outer protrusion. The lowermost end of the outer protrusion of the first side part may be located on the same line as the lowermost end of the lower part, while the uppermost end of the outer protrusion of the second side part may be located on the same line as or higher than the uppermost end of the mounting member 320 to be described later.

Due to this, the outer protrusions of the first side part 100 and the second side part 150 protect the lowermost part of the lower part and the uppermost part of the mounting member 320 to be described later, and even when an impact is applied from the side, the battery module 200 may be effectively protected.

Next, referring to FIGS. 3 and 4, the inside of the battery case will be described in detail. The mounting member 320 extending in the longitudinal direction of the vehicle and surrounding the sides of the mounted battery module 200 is formed on each side of the inside of the battery case. The mounting member 320 is provided to surround the sides of the mounted battery module 200 to be mounted and serves to reduce noise and discomfort generated from vibration and to protect the battery module 200 from an external shock by mitigating vibration generated when the battery module 200 is driven.

In addition, the mounting member 320 faces the first side part 100 and is spaced apart from the first side part 100 to form a separation space. As the separation space is formed between the mounting member 320 and the first side part 100, in case of an external collision, the stability of the battery module is ensured by allowing the shock to be absorbed using the separation space.

Next, the cross members provided inside the battery case will be described. A transverse cross member 350 extending in the width direction of the vehicle is formed in the center of the side part of the battery case, and a longitudinal cross member 380 extending in the longitudinal direction of the vehicle is formed at the center of the front portion of the battery case. One transverse cross member 350 and one longitudinal cross member 380 may be provided.

In the case of a conventional battery case, a number of cross members are located inside the battery case, so the limited internal space of the battery case may not be efficiently utilized.

By contrast, in embodiments of the present disclosure, as the lower part 400 in charge of the cooling system of the battery case integrally performs the role of a rigid support in the longitudinal direction of the battery case, the structure of the cross member is simplified, and the number of cross members required is reduced.

A front bottom part 300 connected to the lower part is provided at the front part of the battery case, and the front bottom part 300 is extruded and molded in the longitudinal direction of the vehicle.

Since the front bottom part 300 of the battery case is extruded and molded in the longitudinal direction of the vehicle, it is possible to strengthen the rigidity in the lateral direction and effectively respond to impact and compression caused by a collision occurring in the front of the battery case.

According to the structure of a battery case of embodiments of the present disclosure, as the lower part 400 plays the role of a cooling system as well as a rigid support in the longitudinal direction of the battery case, the structure of a cross member, which is disposed in large numbers in the case of a conventional battery case, is simplified, and the number of cross members required is reduced.

Therefore, it is possible to load more battery modules 200 in the battery case, so that the energy density of the vehicle is increased and the mileage may be increased.

In addition, by forming a passage through which a cooling medium can move in the first side part 100 coupled to the side part of the battery case, no additional parts for distributing the cooling medium to a cooling channel are required unlike in the conventional case, so that a welding process may be saved and costs of battery case materials may be reduced.

What is claimed is:

1. A battery case comprising:
a lower part defining a bottom surface of the battery case, wherein the lower part is configured to have a battery module mounted thereon, is extruded and molded in a width direction of a vehicle, and comprises a cooling channel extending in the width direction of the vehicle, the cooling channel being configured to allow a cooling medium to flow therethrough; and
a first side part coupled to an edge of the lower part to define a side of the battery case, wherein the first side part is extruded and molded in a longitudinal direction of the vehicle, and wherein the first side part comprises:
an inlet/outlet channel extending in the longitudinal direction of the vehicle, the inlet/outlet channel being configured to allow the cooling medium to flow therethrough; and
a connection channel connecting the inlet/outlet channel and the cooling channel.

2. The battery case of claim 1, wherein the lower part is provided in plural, and the lower parts are disposed in contact with each other on a same plane to define the bottom surface of the battery case.

3. The battery case of claim 1, wherein the cooling channel is provided in plural in the lower part, wherein each of the cooling channels extends in the width direction of the vehicle, and wherein the cooling channels are spaced apart from each other in the longitudinal direction of the vehicle.

4. The battery case of claim 1, wherein the first side part is coupled to first and second sides of the lower part, wherein an inlet channel of the inlet/outlet channel is provided in the first side part on the first side of the lower part and an outlet channel of the inlet/outlet channel is provided in the first side part on the second side of the lower part, and wherein the battery case is configured to allow the cooling medium to be introduced through the inlet channel, to pass through the cooling channel of the lower part, and to be discharged to an outside of the battery case through the outlet channel.

5. The battery case of claim 1, wherein the inlet/outlet channel of the first side part has a diameter in a height direction that is larger than a diameter of the connection channel in the height direction.

6. The battery case of claim 1, wherein a first end of the inlet/outlet channel of the first side part is connected to a cooling line of the vehicle and a second end of the inlet/outlet channel of the first side part is closed by a closing portion.

7. The battery case of claim 1, further comprising:
a battery upper case; and
a second side part located on top of the first side part and configured to define the side of the battery case together with the first side part, wherein an upper end of the second side part is coupled to both ends of a lower surface of the battery upper case.

8. The battery case of claim 7, further comprising a joint portion comprising a plurality of curves provided on a lower surface of the second side part and an upper surface of the first side part, wherein the second side part and the first side part are configured to be connected through the joint portion.

9. A battery case comprising:
a lower part defining a bottom surface of the battery case, wherein the lower part is configured to have a battery module mounted thereon, is extruded and molded in a width direction of a vehicle, and comprises a cooling channel extending in the width direction of the vehicle, the cooling channel being configured to allow a cooling medium to flow therethrough;
a first side part coupled to an edge of the lower part to define a side of the battery case, wherein the first side part is extruded and molded in a longitudinal direction of the vehicle, and wherein the first side part comprises:
an inlet/outlet channel extending in the longitudinal direction of the vehicle, the inlet/outlet channel being configured to allow the cooling medium to flow therethrough; and
a connection channel connecting the inlet/outlet channel and the cooling channel; and
a mounting member extending in the longitudinal direction of the vehicle on opposite sides of an inside of the battery case, wherein the mounting member is configured to surround sides of the mounted battery module and is located on an upper surface of the lower part and faces the first side part laterally.

10. The battery case of claim 9, wherein the mounting member and the first side part are arranged to be spaced apart from each other to define a separation space between the mounting member and the first side part.

11. The battery case of claim 10, wherein the connection channel of the first side part is located in the separation space and connects the inlet/outlet channel and the cooling channel.

12. The battery case of claim 9, further comprising a second side part coupled to a top of the first side part, and wherein:
the first side part and the second side part each define an outer protrusion; and
a lowermost end of the outer protrusion of the first side part is located on a same line as a lowermost end of the lower part and an uppermost end of the outer protrusion of the second side part is located on a same line as or higher than an uppermost end of the mounting member.

13. The battery case of claim 9, wherein the inlet/outlet channel of the first side part has a diameter in a height direction that is larger than a diameter of the connection channel in the height direction.

14. The battery case of claim 9, wherein a first end of the inlet/outlet channel of the first side part is connected to a cooling line of the vehicle and a second end of the inlet/outlet channel of the first side part is closed by a closing portion.

15. The battery case of claim 9, further comprising:
a battery upper case; and
a second side part located on top of the first side part and configured to define the side of the battery case together with the first side part, wherein an upper end of the second side part is coupled to both ends of a lower surface of the battery upper case.

16. The battery case of claim 15, further comprising a joint portion comprising a plurality of curves provided on a lower surface of the second side part and an upper surface of the first side part, wherein the second side part and the first side part are configured to be connected through the joint portion.

17. A battery case comprising:
a plurality of lower parts disposed in contact with each other on a same plane to define a bottom surface of the battery case, wherein each of the lower parts:
is configured to have a battery module mounted thereon;
is extruded and molded in a width direction of a vehicle; and
comprises a cooling channel extending in the width direction of the vehicle, the cooling channel being configured to allow a cooling medium to flow therethrough;
a first side part coupled to an edge of the lower part on first and second sides of the lower part to define sides of the battery case, wherein the first side part is extruded and molded in a longitudinal direction of the vehicle, and wherein the first side part comprises:
an inlet/outlet channel extending in the longitudinal direction of the vehicle, the inlet/outlet channel being configured to allow the cooling medium to flow therethrough, and the inlet/outlet channel comprising an inlet channel in the first side part on the first side of the lower part and an outlet channel in the first side part on the second side of the lower part; and
a connection channel connecting the inlet/outlet channel and the cooling channel;
a battery upper case; and
a second side part located on top of the first side part and configured to define the sides of the battery case together with the first side part, wherein an upper end of the second side part is coupled to both ends of a lower surface of the battery upper case.

18. The battery case of claim 17, wherein the battery case is configured to allow the cooling medium to be introduced through the inlet channel, to pass through the cooling channels of the lower parts, and to be discharged to an outside of the battery case through the outlet channel.

19. The battery case of claim 17, wherein the inlet/outlet channel of the first side part has a diameter in a height direction that is larger than a diameter of the connection channel in the height direction.

20. The battery case of claim 17, further comprising a joint portion comprising a plurality of curves provided on a lower surface of the second side part and an upper surface of the first side part, wherein the second side part and the first side part are configured to be connected through the joint portion.
